(19) United States
(12) Patent Application Publication
(10) Pub. No.: US 2014/0308841 A1
(43) Pub. Date: Oct. 16, 2014

(54) CONNECTOR ASSEMBLY

(71) Applicants: HON HAI PRECISION INDUSTRY CO., LTD., New Taipei (TW); HONG FU JIN PRECISION INDUSTRY (WUHAN) CO., LTD., Wuhan (CN)

(72) Inventors: ZHI-MING ZHU, Wuhan (CN); MING-HUI LUO, Wuhan (CN); TING WANG, Wuhan (CN); SAN-YONG YANG, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/065,618

(22) Filed: Oct. 29, 2013

(30) Foreign Application Priority Data
Apr. 16, 2013 (CN) 201310130464X

(51) Int. Cl. H01R 13/642; H01R 13/627

(52) U.S. Cl. CPC H01R 13/642; H01R 13/6271
USPC 439/357; 439/374

(57) ABSTRACT

A connector assembly includes a first connector and a second connector. The first connector defines a plurality of inserting holes. A receiving slit defined between adjacent two of the plurality of inserting holes. The second connector includes a plurality of pins. A positioning piece is formed between adjacent two of the plurality of pins. The second connector is inserted in the first connector when the positioning piece is aligned to the receiving slit. The positioning piece abuts an outer portion of the first connector to prevent the second connector from being wrongly inserted in the first connector when the positioning piece is not aligned to the receiving slit.

### BACKGROUND

1. Technical Field

The present disclosure relates to connector assemblies, and particularly to a connector assembly with a foolproof mechanism.

2. Description of Related Art

A connector assembly is used for transmitting data between two electronic devices. The connector assembly includes a first connector with a plurality of inserting slots and a second connector with a plurality of plugs. Each of the plugs must be inserted into each of the inserting slots before the connector assembly can function. However, one of the plugs maybe easily inserted in a wrong direction. Therefore, there is room for improvement in the art.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of a connector assembly.

FIG. 2 is an isometric view of a second connector of the connector assembly of FIG. 1.

FIG. 3 is an assembled view of the connector assembly of FIG. 1.

FIG. 4 is an isometric view of connector assembly of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

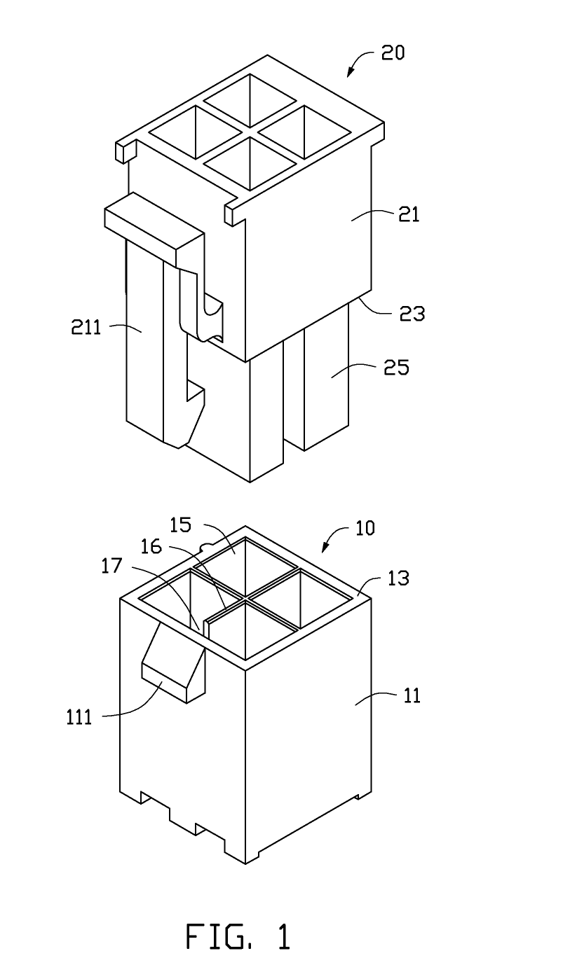

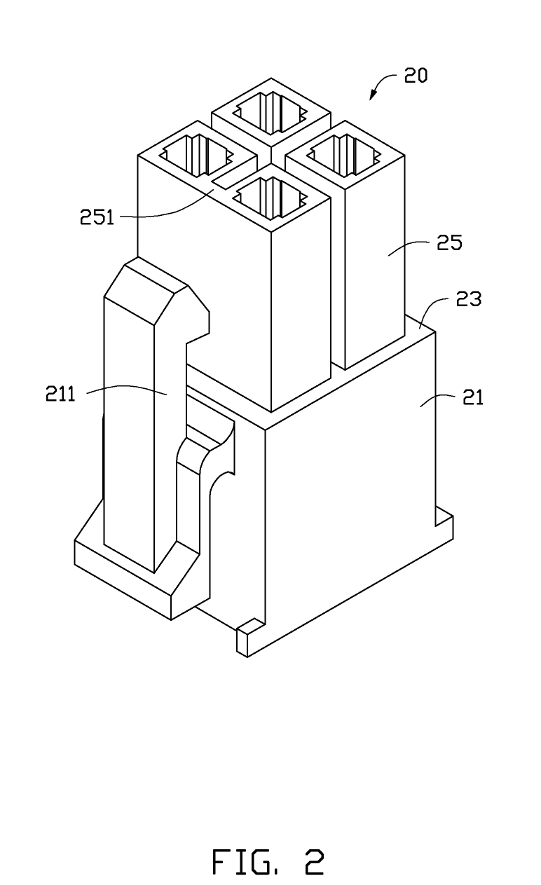

FIGS. 1 and 2 illustrates an embodiment of a connector assembly. The connector assembly includes a first connector 10 and a second connector 20.

The first connector 10 is a formed in a rectangular block and includes four side walls 11 and a top wall 13 perpendicularly connected to the four side walls 11. An engaging portion 111 is protruded on one of the four side walls 11. The top wall 13 of the first connector 10 defines four inserting holes 15 which are aligned in two lines and two rows. Two adjacent inserting holes 15 are separated by a separating piece 16. The separating piece 16 is formed in a “+” shape. A receiving slit 17 is defined in the separating piece 16 and located adjacent the engaging portion 111.

The second connector 20 includes four side walls 21 and a bottom wall 23 perpendicularly connected to the four side walls 21. One of the four side walls 21 defines a clasp 211 corresponding to the engaging portion 111 of the first connector 10. Four pins 25 are formed in the bottom wall 23. The pins 25 are downwardly extending and located in two lines and two rows. A positioning piece 251 is formed on the connector 20 adjacent the clasp 211. The positioning piece 251 is connected between two adjacent pins 25. A height of the positioning piece 251 is smaller than a depth of the receiving slit 17.

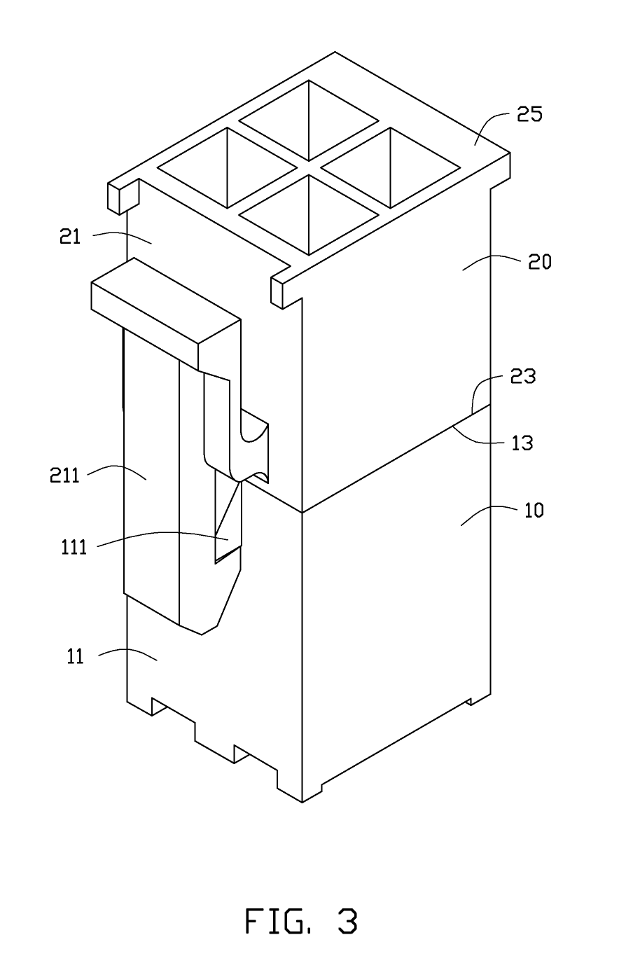

FIG. 3 shows that when the second connector 20 is connected to the first connector 10 in a right direction, the positioning piece 251 is aligned to the receiving slit 17. The pins 25 of the second connector 20 are inserted in the inserting slots 15 of the first connector 10. The positioning piece 251 is inserted in the receiving slit 17. The bottom piece 23 of the second connector 20 abuts the top wall 13 of the first connector 10. Simultaneously, the clasp 211 engages on the engaging portion 111 to secure the first connector 10 to the second connector 20.

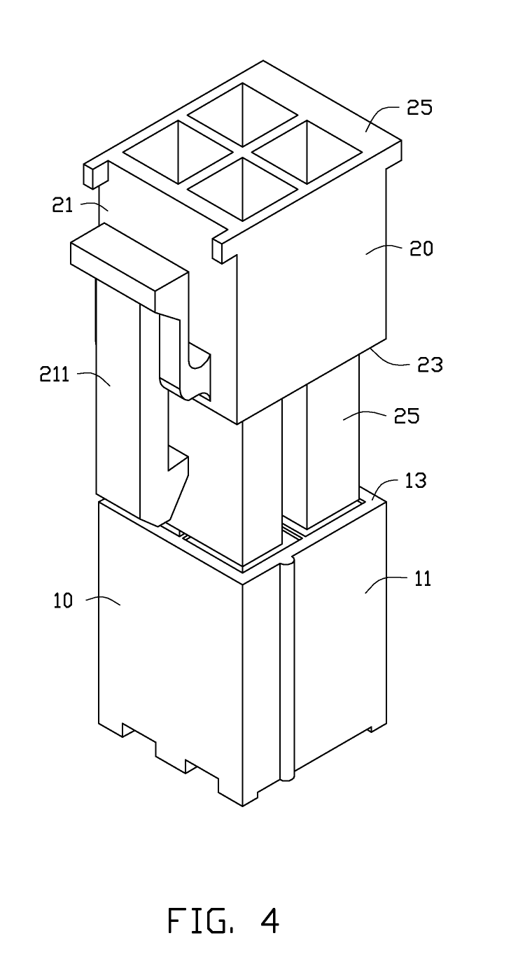

FIG. 4 shows that when the second connector 20 is connected to the first connector 10 in a wrong direction, the positioning piece 251 of the second connector 20 is misaligned with the receiving slit 17 of the first connector 10. When the second connector 20 is inserted in the first connector 10, the positioning piece 251 of the second connector 20 abuts the separating piece 16 of the first connector 10 to prevent the second connector 20 from being wrongly connected to the first connector 10.

It is to be understood, however, that even though numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A connector assembly, comprising:
a first connector comprising a plurality of inserting holes, a receiving slit defined between adjacent two of the plurality of inserting holes; and
a second connector comprising a plurality of pins, a positioning piece formed between adjacent two of the plurality of pins;
wherein the second connector is configured to be inserted in the first connector when the positioning piece is aligned to the receiving slit, and the positioning piece is configured to abut an outer portion of the first connector and prevent the second connector from being inserted in the first connector when the positioning piece is not aligned to the receiving slit.

2. The connector assembly of claim 1, wherein adjacent two of the plurality of inserting holes are separated by a separating piece.

3. The connector assembly of claim 2, wherein the receiving slit is defined in the separating piece.

4. The connector assembly of claim 1, wherein a height of the positioning piece is smaller than a depth of the receiving slit.

5. The connector assembly of claim 1, wherein the first connector comprises an engaging portion, the second connector comprises a clasp, and the clasp is configured to engage on the engaging portion when the second connector is inserted in the first connector.

6. The connector assembly of claim 5, wherein the receiving slit is adjacent to the engaging portion, and the positioning piece is located adjacent to the clasp.

7. The connector assembly of claim 1, wherein the plurality of inserting holes are aligned in a two by two grid.

8. The connector assembly of claim 7, wherein the plurality of pins are aligned to the two by two grid.

9. A first connector, comprising:
a plurality of side walls and a top wall connected to each of the plurality of side walls;
a plurality of inserting holes defined in the top wall, a separating piece separating each adjacent two of the plurality inserting holes;
a receiving slit defined in the separating piece; and
an engaging portion formed on one of the plurality of side walls and located adjacent to the receiving slit.

10. The first connector of claim 9, wherein the plurality of inserting holes are aligned in a two by two grid.

11. A second connector, comprising:
a plurality of side pieces and a bottom piece connected to each of the plurality of side pieces;
a plurality of pins formed on the bottom piece;
a positioning piece connected between adjacent two of the plurality of pins; and
a clasp formed on one of the plurality of side pieces and located adjacent to the positioning piece.

12. The second connector of claim 11, wherein the plurality of pins are aligned in a two by two pins.
